(19) United States
(12) Patent Application Publication
(10) Pub. No.: US 2017/0081903 A1
(43) Pub. Date: Mar. 23, 2017

(54) ONE PIECE WINDOW REINFORCEMENT FOR WINDOW FRAME ASSEMBLY

(71) Applicant: Milgard Manufacturing Incorporated, Tacoma, WA (US)

(72) Inventor: Melvin Saunders, Auburn, WA (US)

(73) Assignee: Milgard Manufacturing Incorporated, Tacoma, WA (US)

(21) Appl. No.: 15/270,637

(22) Filed: Sep. 20, 2016

Related U.S. Application Data
(60) Provisional application No. 62/221,898, filed on Sep. 22, 2015.

(51) Int. Cl. E06B 3/06; E06B 3/54

(52) U.S. Cl. CPC E06B 3/06; E06B 3/5454

(57) ABSTRACT

A frame assembly for a fenestration assembly includes a frame having a first side, a second side, a third side, and a fourth side. A groove is disposed continuously along the first side, the second side, the third side and the fourth side. A one piece reinforcement is disposed within the groove of the frame and a trim assembly positioned over the one piece reinforcement and the frame.

### CROSS-REFERENCE TO RELATED PATENT APPLICATIONS

This application claims priority to U.S. Provisional Application No. 62/221,898, filed Sep. 22, 2015, entitled “One Piece Window Reinforcement For Window Frame Assembly” and incorporated herein by reference in its entirety.

### BACKGROUND OF THE INVENTION

The present invention relate generally to the construction of fenestration assemblies and in particular to a one piece reinforcement for a frame in a fenestration assembly.

Window frames may include a hollow profile that is typically filled with multiple pieces of reinforcing material, such as aluminum or steel extrusion, to stiffen the frame. The pieces of reinforcing material, however, are typically separate and the frame may still flex substantially at the corners of the frame. As a result, many existing methods of reinforcement use thick pieces of reinforcing material which may be less energy efficient.

It would be desirable to provide a method for reinforcing a window or window sash frame that uses a single piece reinforcement that may reduce the frame profile and increase stiffness in the corners of the frame.

### SUMMARY OF THE INVENTION

In accordance with an embodiment, a frame assembly for a fenestration assembly includes a frame comprising a first side, a second side, a third side, a fourth side and a groove disposed continuously along the first side, the second side, the third side and the fourth side, a one piece reinforcement disposed within the groove of the frame; and a trim assembly positioned over the one piece reinforcement and the frame.

### BRIEF DESCRIPTION OF THE DRAWINGS

FIG. 1 is a perspective view of a frame for a window or window sash in accordance with an embodiment;

FIG. 2 is an exploded or perspective view of the frame of FIG. 1 in accordance with an embodiment; and

FIG. 3 is a cross-sectional view of the frame of FIG. 1 in accordance with an embodiment.

### DETAILED DESCRIPTION OF THE PREFERRED EMBODIMENTS

The following description discusses a frame assembly for a fenestration assembly. While the following description refers to windows, it should be understood that the frame assembly described herein may also be used with other types of fenestration assemblies (e.g., doors). In addition, the frame assembly described herein may be used with any operating style of window such as, for example, casement, single hung, double hung, and horizontal sliding windows.

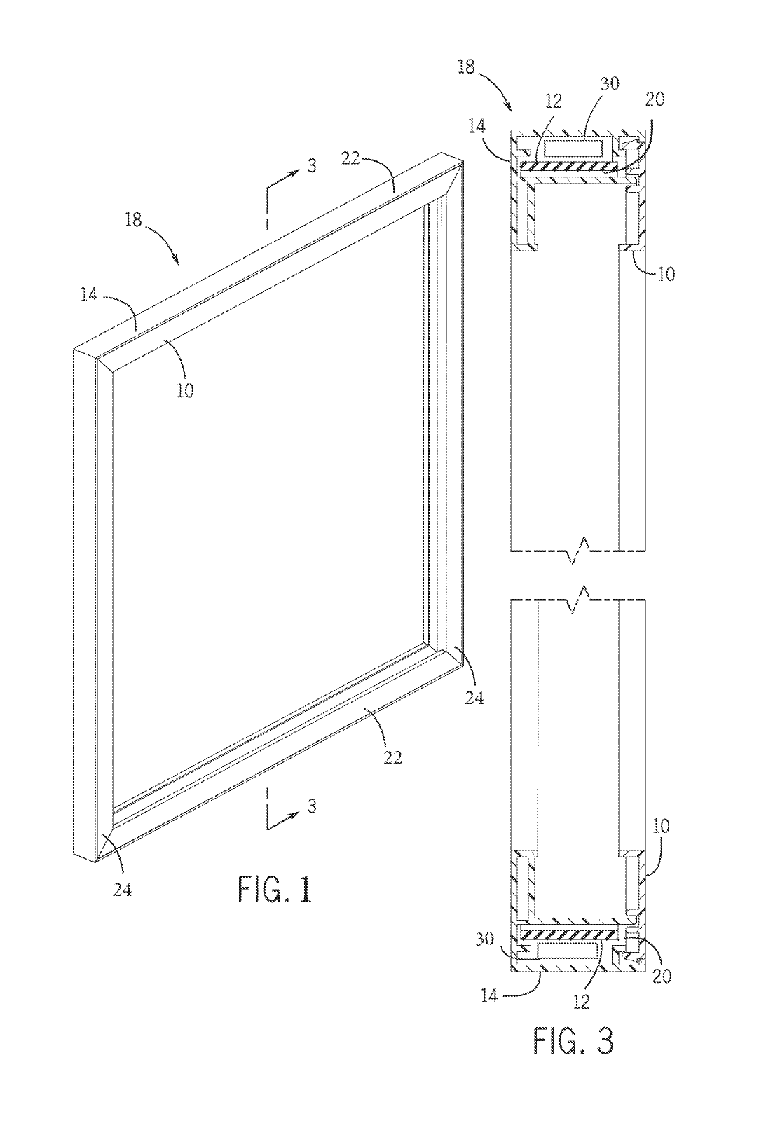

FIG. 1 is a perspective view of a frame for a window or window sash in accordance with an embodiment. Window (or window sash) 18 includes a trim assembly 10 and a frame 14 with rails 22 and stiles 24. The frame 14 may be constructed from any material suitable for a window such as, for example, wood, vinyl, a composite material, or a plastic material. A glazing (not shown) may be housed within the frame 14. In various exemplary embodiments, the glazing may include a single piece of glass, double panes of glass, triple panes of glass, or any other number of panes. Frame 14 also includes a one piece reinforcement as shown in FIG. 2.

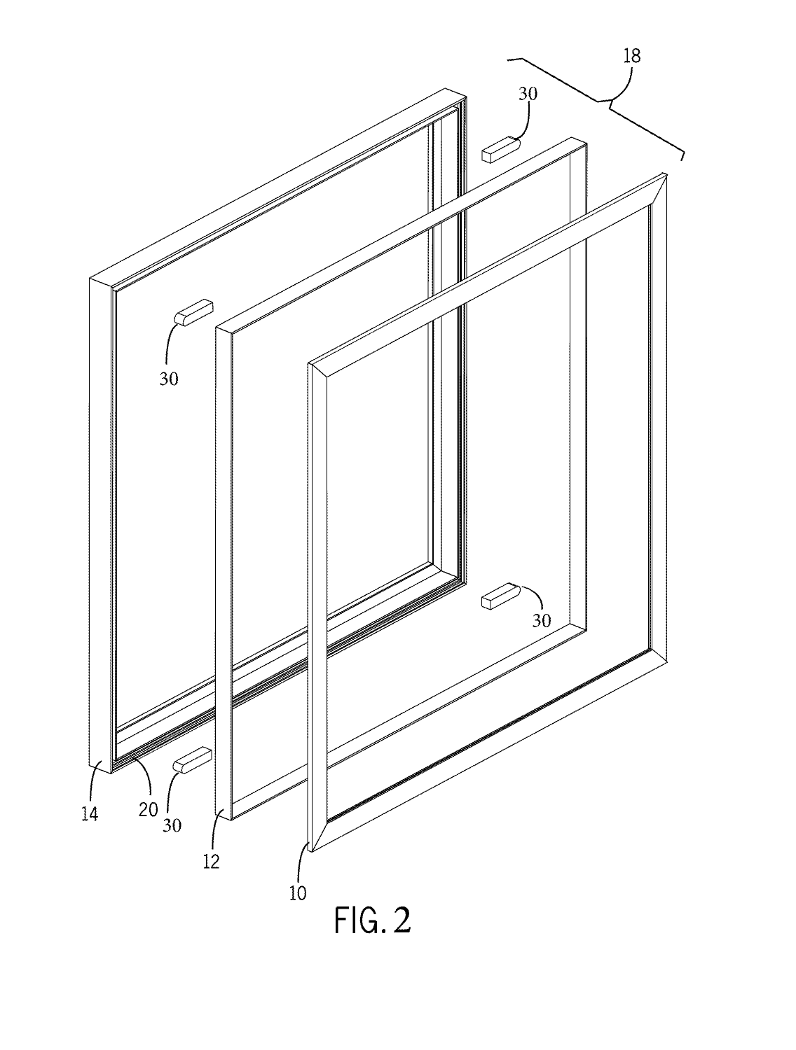

FIG. 2 is an exploded or perspective view of the frame of FIG. 1 in accordance with an embodiment. The frame 14 includes a groove 20. Groove 20 is continuous along each rail 22 and stile 28 (i.e., along each of the four sides) of the frame 14. A one piece reinforcement 12 is received within the groove 20. Spacers 30 are positioned in each corner of the frame 14 between the one piece reinforcement 12 and the frame 14. The one piece reinforcement 12 acts as a single monolithic structure that stiffens both the sides and corners of the frame rather than having four flexible corners. The one piece reinforcement 12 may be constructed from a material such as, for example, aluminum. In various exemplary embodiments, other components such as tilt latches (not shown) and pivot bars (not shown) may also be integrated into the one piece reinforcement 12. A trim assembly 10 is positioned over the frame 14 and one piece reinforcement 12 to complete the frame assembly. FIG. 3 is a cross-sectional view of the frame of FIG. 1 in accordance with an embodiment. FIG. 3 illustrates the cross section along line 3-3 of FIG. 1. The one piece reinforcement 12 is positioned within the groove 20 of the frame 14.

In one embodiment, groove 20 is routed into frame 14. With standard windows with no reinforcement the components of the frame must have sufficient mass to support the rigidity of the frame and the glazing. The one piece reinforcement allows for enhanced rigidity of the window 18 and glazing assembly with the frame 14 having a smaller width and thickness. Stated another way, for a window without a one piece reinforcement to have the same rigidity of a window with a one piece reinforcement the width and thickness of the frame without the one piece reinforcement must be greater than the width and/or thickness of the frame with a one piece reinforcement. The use of a one piece reinforcement allows the window to have a smaller width and/or thickness than a window without the one piece reinforcement while maintaining the same rigidity or better rigidity than the window without the one piece reinforcement. The smaller frame width and/or thickness allows for greater viewing ratio of glazing to frame thickness. The term rigidity as used herein includes the resistance of the frame to movements when a bending moment, shear, and axial loads are applied to the frame. The greater the rigidity, the greater resistance to movement of the frame to forces applied to the frame included but not limited to the force of gravity applying a bending moment, shear or axial load to the frame. In one embodiment, frame 14 includes a groove 20 that is routed into a single piece of material defining the frame 14 thereby eliminating the need for corner connectors of individual frame members. This aspect in combination with the one piece reinforcement member acts to further increase the rigidity of the finished frame with the one piece reinforcement member.

It is important to note that the construction and arrangement of the frame assembly as described herein is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements and vice versa, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the exemplary embodiments without departing from the scope of the present inventions as expressed in the appended claims.

What is claimed is:

1. A frame assembly for a fenestration assembly, the frame assembly comprising:
a frame comprising a first side, a second side, a third side, a fourth side and a groove disposed continuously along the first side, the second side, the third side and the fourth side;
a one piece reinforcement disposed within the groove of the frame; and
a trim assembly positioned over the one piece reinforcement and the frame.

2. A frame assembly according to claim 1, wherein the frame is a window sash frame.

3. A frame assembly according to claim 1, wherein the groove is routed into the frame.

4. A frame assembly according to claim 1, wherein the frame is formed from a single piece of material.

5. A frame assembly according to claim 4, wherein the groove is routed into the frame.

6. A frame assembly according to claim 1, further comprising a first spacer positioned in a first corner of the frame between the one piece reinforcement and the frame.

7. A frame assembly according to claim 6, further comprising a second spacer positioned in a second corner of the frame between the one piece reinforcement and the frame.

8. A frame assembly according to claim 7, further comprising a third spacer positioned in a third corner of the frame between the one piece reinforcement and the frame.

9. A frame assembly according to claim 8, further comprising a fourth spacer positioned in a fourth corner of the frame between the one piece reinforcement and the frame,.

10. A frame assembly according to claim 1, wherein the one piece reinforcement is formed from aluminum.

11. A frame assembly according to claim 1, wherein the fenestration assembly is a window.

12. A frame assembly according to claim 1, wherein the fenestration assembly is a door.

13. A frame assembly according to claim 1, wherein the fenestration assembly is a window sash,
